(19) United States
(12) Patent Application Publication
(10) Pub. No.: US 2016/0246584 A1
(43) Pub. Date: Aug. 25, 2016

(54) Automatic Selection and Customization of Landscape Guides

(71) Applicants: Biju Balachandran, Bangalore (IN); Niraj Kumar, Bangalore (IN)

(72) Inventors: Biju Balachandran, Bangalore (IN); Niraj Kumar, Bangalore (IN)

(21) Appl. No.: 14/626,735

(22) Filed: Feb. 19, 2015

(51) Int. Cl. G06F 9/445; G06F 9/44; H04L 29/08; G06F 17/30

(52) U.S. Cl. CPC G06F 8/65; G06F 17/30867; G06F 9/4446; H04L 67/34

(57) ABSTRACT

Techniques are described for the automated selection and customization of landscape guides. Landscape guides provide instructions to a customer for making changes to customer landscapes. A customer landscape is an arrangement of servers or other computer systems. During the lifecycle of the customer landscape, the customer landscape may change due to software upgrades, software updates, or software installations. Based on a customer request for a customer landscape change, the techniques can automatically select landscape guides which are relevant to the landscape change and automatically customize the selected landscape guides such that the guides are tailored for the customer.

### BACKGROUND

A customer landscape is an arrangement of servers or other computer systems. During the lifecycle of the customer landscape, software upgrades can be available for software applications running on servers within the customer landscape. These software upgrades can be complicated to install. As a result, customers follow installation guides to perform the upgrade. Depending on the software upgrade, multiple guides may be required.

To implement a software upgrade, a customer typically needs to visit an online library and manually locate the guides which are followed to perform the upgrade. This can be confusing and time consuming process to locate the guides. Once the desired guides are located, the customer downloads the guides. Given that different customers run different landscape configurations (e.g., operating systems, databases), each guide is universal in nature and contains instructions for installing the software upgrade on different operating systems and databases. A customer who that is trying to follow a downloaded guide may find it difficult to identify the portions of the guide that are relevant to the customer. As a result, the customer can get frustrated over the software upgrade process. This frustration can be compounded given that software upgrades can have multiple dependencies and thus, upgrading one software application can require the upgrade of many other software applications within the customer landscape.

### SUMMARY

In one embodiment, a computer-implemented method receives, by a processor, a customer request to modify a customer landscape that includes a plurality of computer systems, wherein the customer request describes a desired configuration for a software application to execute on a computer system of the customer landscape. The method then retrieves, by the processor, information describing a current configuration of the software application or the computer system. The method then determines, by the processor, a software logistics process according to the current configuration and the desired configuration, the software logistics process describing a process to implement the desired configuration of the software application. The method then generates, by the processor, a landscape guide query according to the software logistics process, the customer request, and the information, the landscape guide query being configured to identify a plurality of landscape guides stored in a guides database, the plurality of landscape guides providing instructions to implement the desired configuration of the software application. The method then runs, by the processor, the landscape guide query. The method then receives, by the processor, the plurality of landscape guides returned from the query.

In one example, the method further includes customizing, by the processor, a landscape guide from the plurality of landscape guides according to the information describing the current configuration of the software application. Customizing the landscape guide can include removing, by the processor, one or more instructions from the landscape guide that are irrelevant to the current configuration of the software application.

In another example, information includes at least one of a source product version configured to identify the version of the software application that is installed on the computer system, an operating system identifier configured to identify the operating system executing on the computer system, and a database identifier configured to identify the database utilized by the computer system.

In another example, retrieving information describing the current configuration of the software application or the computer system includes determining, by the processor, a system identifier for the computer system from the customer request and retrieving, by the processor, the information from a customer profile database according to the system identifier.

In another example, determining the software logistics process includes comparing, by the processor, a first version identifier for the current configuration against a second version identifier for the desired configuration and determining, by the processor, the software logistics process based on the comparison. The software logistics process can be determined to be an installation when the first version identifier is set to NIL

In another embodiment, a non-transitory computer readable storage medium stores one or more programs comprising instructions for receiving a customer request to modify a customer landscape that includes a plurality of computer systems, wherein the customer request describes a desired configuration for a software application to execute on a computer system of the customer landscape, retrieving information describing a current configuration of the software application or the computer system, determining a software logistics process according to the current configuration and the desired configuration, the software logistics process describing a process to implement the desired configuration of the software application, generating a landscape guide query according to the software logistics process, the customer request, and the information, the landscape guide query being configured to identify a plurality of landscape guides stored in a guides database, the plurality of landscape guides providing instructions to implement the desired configuration of the software application, running the landscape guide query, and receiving the plurality of landscape guides returned from the query.

In another embodiment, a computer implemented system comprises one or more computer processors and a non-transitory computer-readable storage medium. The non-transitory computer-readable storage medium comprises instructions, that when executed, control the one or more computer processors to be configured for receiving a customer request to modify a customer landscape that includes a plurality of computer systems, wherein the customer request describes a desired configuration for a software application to execute on a computer system of the customer landscape, retrieving information describing a current configuration of the software application or the computer system, determining a software logistics process according to the current configuration and the desired configuration, the software logistics process describing a process to implement the desired configuration of the software application, generating a landscape guide query according to the software logistics process, the customer request, and the information, the landscape guide query being configured to identify a plurality of landscape guides stored in a guides database, the plurality of landscape guides providing instructions to implement the desired configuration of the software application, running the landscape guide query, and receiving the plurality of landscape guides returned from the query.

The following detailed description and accompanying drawings provide a better understanding of the nature and advantages of the present disclosure.

### BRIEF DESCRIPTION OF THE DRAWINGS

FIG. 1a illustrates a system for providing customized landscape guides;

FIG. 1b illustrates a workflow for providing guides to a customer according to one embodiment;

FIG. 2 illustrates a guides database according to one embodiment;

FIG. 3 illustrates an execution process according to one embodiment; and

FIG. 4 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Described herein are techniques for the automated selection and customization of landscape guides that provide instructions use of updating or upgrading customer landscapes. A customer landscape is an arrangement of servers or other computer systems. During the lifecycle of the customer landscape, the customer landscape may change. Changes to the customer landscape can be due to software upgrades or software updates made to software applications running on servers within the customer landscape. Changes to the customer landscape can also result from the installation of new software application within the customer landscape. To make the changes to the customer landscape, the customer can follow installation guides to perform the desired change to the customer landscape. Depending on the change, multiple guides may be required. In some embodiments, the techniques can automatically identify the software logistics process to perform in order to update the customer landscape with a desired source software product version (SSPV). Based on the software logistics process, the techniques can automatically select the needed landscape guides and optionally customize the landscape guides for a particular customer. Advantages to these techniques include simplification of the process for downloading landscape guides. The downloaded landscape guides have also been customized for the particular customer, thus making the landscape guides simpler to follow.

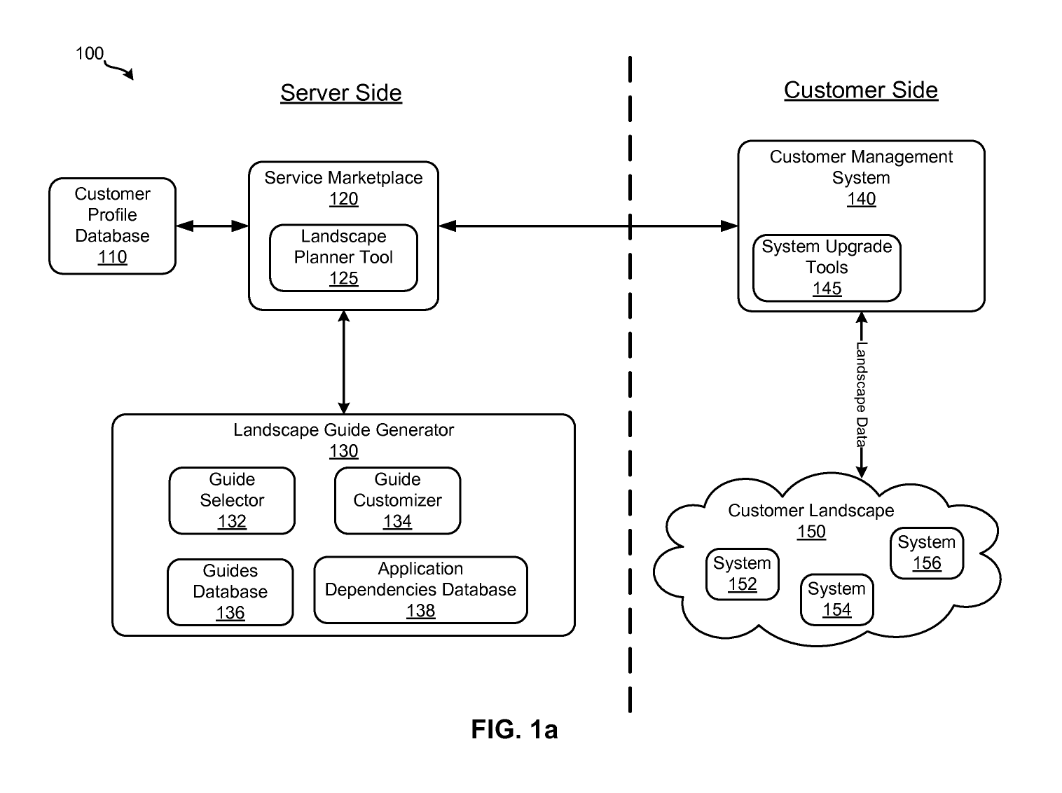

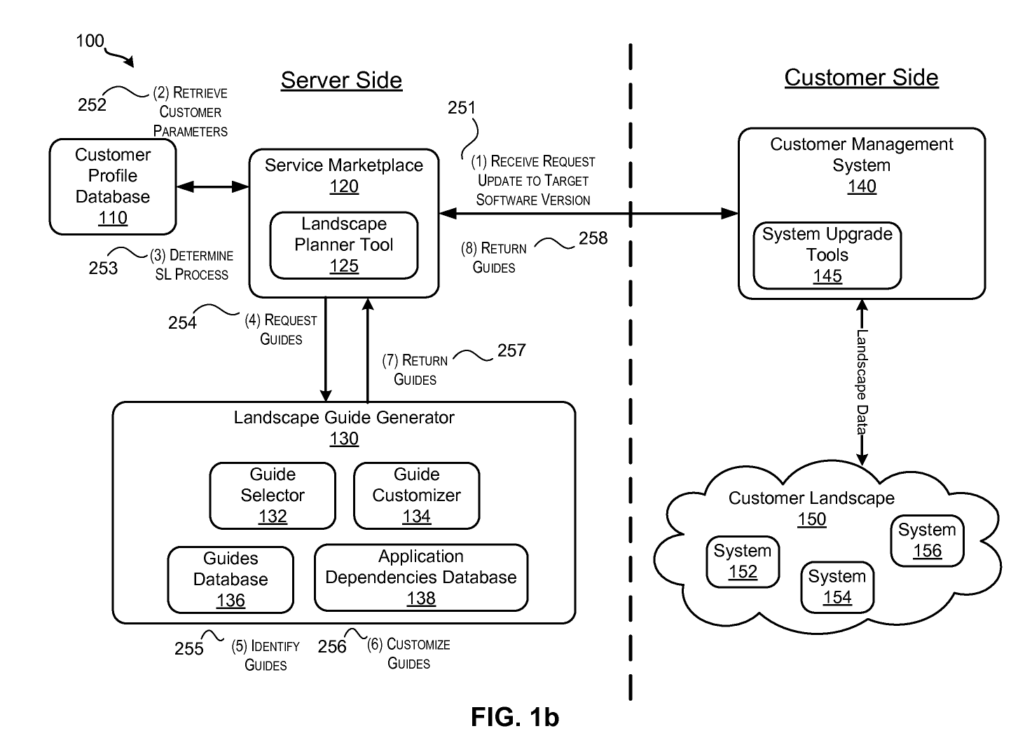

FIG. 1a illustrates a system for providing customized landscape guides. System 100 include customer management system 140. Customer management system 140 is configured to manage the state of customer landscape 150. This can include managing the state of each computer system within customer landscape 150. This can also include managing changes to customer landscape 150. Changes to customer landscape 150 can result from updating, upgrading, or installing a software application on a computer system within customer landscape 150. Customer landscape 150 is configured to host a variety of computer systems (e.g., system 152, 154, and 156) on the customer side. Each computer system can be configured to run one or more software applications. In one embodiment, a customer can utilize customer management system 140 to make changes to customer landscape 150. The changes can include the selection of software applications to upgrade, update, or install on a computer system within customer landscape 150.

Customer management system 140 includes system upgrade tools 145. System upgrade tools 145 is configured to manage the update, upgrade, or installation of software within customer landscape 150. For example, system upgrade tools 150 can manage the upgrade of a software application running on a system within customer landscape 150. Together, customer management system 140 and customer landscape 150 make up the customer side of system 100.

System 100 further includes a server side which includes customer profile database 110, service marketplace 120, and landscape guide generator 130. Service marketplace 120 is configured to provide support for software applications, analytics solutions and platform support, including software download, license key requests, and customer messages. Customers who wish to download software or seek support for software applications can communicate directly with service marketplace 120. Service marketplace 120 includes landscape planner tool 125. Landscape planner tool 125 is a software application on the server side which is configured to process landscape planning requests. Landscape planning requests can a request to upgrade, update, or install a software application on a computer system within customer landscape 150. In one example, the requests can be received from customer management system 140. In one embodiment, landscape planner tool 125 can be configured to determine the software logistics process to perform in response to a customer's request. The software logistics process can specify one or more software applications which are to be upgraded, updated, or installed in order to process the customer's request. For example, the software logistics process can specify one or more additional software applications besides the software specified in the request which are to be upgraded in order to satisfy the customer's request. For instance, the customer's request can be to upgrade software application A. However, executing upgraded version of software application A may depend on an updated version of software application B. As a result, landscape planner tool 125 can determine that upgrading software application A can require updating both software application A and software application B. As a result, landscape planner tool 125 can generate a software logistics process that identifies software application A and software application B as applications which are going to be upgraded.

Landscape guide generator 130 is configured to provide landscape guides to the customer. Each landscape guide can provide instructions for changing customer landscape 150. As described above, the changes to customer landscape 150 can be the installation of a software application on a system within customer landscape 150, the upgrade of an existing software application within customer landscape 150, or an update to an existing software application within customer landscape 150. An update can be a smaller change to the software application while an upgrade can be a larger change to the software application. A customer can follow the instructions provided in the landscape guide to change customer landscape 150. For example, a customer may be running version 7.0 of an operating system. Version 6.3 of a software application may require version 7.3 of the operating system. Therefore if the customer wanted to run version 6 of a software application, the customer may need a guide to implement version 6 of the software, a guide to implement version 7.3 of the operating system, a guide to operate software provisioning manager (a tool to provision software on a system), and a guide for operating the software update manager (the tool to update software on a system). In one embodiment, landscape guide generator 130 can be configured to receive parameters for changing customer landscape 150 and in turn return one or more guides based on the received parameters. For example, the parameters can specify the operating system, the database, the source version (i.e., current version) of a software product installed on a server, and a target version (i.e., desired version) of the software product. In response to the received parameters, landscape guide generator 130 can provide guides for the customer. Instead of having the customer manually locate the guides, landscape guide generator 130 can automatically locate the needed guides. In some embodiments, landscape guide generator 130 can also customize the guides for a particular customer.

Landscape guide generator 130 can include guide selector 132, guide customizer 134, guides database 136, and application dependencies database 138. Guides database 136 can include a database of landscape guides that are used to upgrade various applications within the customer landscape. The landscape guides within guides database 136 can include tool guides, upgrade guides, and installation guides. Application dependencies database 138 can contain data describing the dependencies between applications. For example, application dependencies database 138 can identify application B as having to be updated to version 4 when application A is updated to version 3. Dependencies between applications and application versions can be stored as mappings in application dependencies database 138. Guide selector 132 can be configured to select guides from guides database 136 based on the application dependencies database 138. Given a current customer landscape (which includes the versions of the applications currently installed within the landscape) and the desired changes to the customer landscape (e.g., updates, upgrades, and/or installations of software applications), guide selector 132 can select guides within guides database 136 to provide to the customer. Guide customizer 134 can be configured to customize the provided guides such that the guides are specific to the customer. For example, a single guide can include directions for performing an upgrade or update under different operating systems and databases. Guide customizer 134 can generate a personalized guide which contains instructions in the customer's language and tailored for the customer's operating system and/or database. For example, portions of the guide related to languages/operating systems/databases other than those used in the customer landscape can be removed when generating the personalized guide. By removing portions of the landscape guide that are not relevant to the customer, a smaller, more concise version of the landscape guide is generated. The more concise version of the landscape guide can be easier for the customer to follow and can also take up less storage space and therefore minimizing the amount of data that is transmitted to the customer and the storage footprint of the landscape guides once received by the customer. Moreover, the personalized guide can be more intuitive for the customer to follow since portions of the guide that are not relevant to the customer have been removed.

FIG. 1b illustrates a workflow for providing guides to a customer according to one embodiment. As shown, service marketplace 120 can receive a request from the customer at step 1 (reference numeral 251). The customer request can be to change the customer landscape such that the target software version (e.g., target product version) of a requested application is installed on a specified system within customer landscape 150. Service marketplace 120 can process the customer request by retrieving customer parameters from customer profile database 110 at step 2 (reference numeral 252). In one embodiment, service marketplace 120 can determine a system identifier that uniquely identifies the system or customer landscape which is being updated. The system identifier can be received as part of the customer request or alternatively can be mapped or otherwise determined from an identifier in the customer request. Based on the system identifier, service marketplace 120 can retrieve parameters of customer landscape 150 from customer profile database 110. In some examples, the customer parameters can specify the source product version (e.g., the version of the requested application that is currently installed on the system or customer landscape), the operating system running on a system within customer landscape, and the database that is being used by the system. In one example, service marketplace 120 can retrieve customer parameters that are relevant to the customer request. For example, service marketplace 120 can query customer profile database 110 using the system identifier and an identifier for the software application which the customer request is attempting to update. Based on the system identifier and the software application identifier, service marketplace 120 can retrieve the current version of the software application, the operating system running on the system which is executing the software application, and/or the type of database that the software application communicates with. In other examples, other attributes of the software application can be retrieved from customer profile database 110.

Once the customer parameters have been retrieved, service marketplace 120 can determine the software logistics process (SL process) at step 3 (reference numeral 253). The SL process describes the action which is being requested by the customer. In one embodiment, service marketplace 120 can evaluate the source product version (e.g., the version of the software application which is installed on the system) and the target product version (e.g., the desired version of the software application to install on the system) to calculate the SL process. For example if the source product version is version 4.5 of a software application and the target product version is version 4.6 of the software application, then service marketplace 120 can determine that the SL process is an upgrade process. Alternatively if the service product version is NIL (e.g., the software application is not installed on the system which results in a NIL product version when the search is performed) and the target product version is 4.0, then service marketplace 120 can determine that the SL process is an installation process. This is due to the fact that the software application is currently not installed on the system and thus the customer is requesting an installation rather than an upgrade. In some examples, the SL process can be one of install, upgrade, or update.

Once the SL process has been determined, service marketplace 120 can transmit a guide request to landscape guide generator 130 at step 4 (reference numeral 254). The guide request is configured to request landscape guides from landscape guide generator 130. In one embodiment, the guide request can include parameters such as the SL process, the operating system, the target product version for the requested application, and the database which the application is configured to operate with. Landscape guide generator 130 provides landscape guides in response to the guide request. In one embodiment, guide selector 132 can identify landscape guides which are relevant to the guide request in guides database 136 at step 5 (reference numeral 255). Guide selector 132 can identify landscape guides based on the parameters of the guide request. For example, a landscape guide can be located based on the SL process, operating system, target product version, or the database. Exemplary landscape guides can include an implementation guide for the target product version of the software, a guide to implement a version of the operating system, a guide to operate software provisioning manager (a tool to provision software on a system), and a guide for operating the software update manager (the tool to update software on a system).

In one embodiment, guide selector 132 performs a check to determine whether the target product version of the requested application depends on a version of another software application. For example, installing version 4.0 of an application may require the installation of version 3.0 of another application. Guide selector 132 can determine from application dependencies database 138 the dependent applications which also may need to be upgraded, updated, or installed along with the target product version of the requested application. For example, guide selector 132 can determine that target product version 4.5 of a requested software application A is dependent on product version 5.0 of software application B to be installed on the same computer system. In other words, product version 4.5 of software application A expects that product version 5.0 of software application B is also installed on the computer system. If dependent software applications are identified, guide selector 132 can query customer profile database 110 to determine the versions of the dependent software applications which are installed on the customer system. If the versions currently installed on the customer system do not match the desired versions of the dependent software applications have already been installed on the system, then guide selector 132 can identify landscape guides to install the desired versions onto the computer system. Once the guides have been identified, guide customizer 134 can download the guides from guides database 136.

Guide customizer 134 can also customize the downloaded guides at step 6 (reference numeral 256). In one embodiment, guide customizer 134 can configure a downloaded guide by removing portions of the downloaded guide that are not relevant to the customer. For example, a downloaded guide can include instructions for different operating systems and different databases. Guide customizer 134 can determine the operating system or database used by the customer and customize the downloaded guide based on the customer's operating system or database. Customization can include removing instructions other than ones relevant to the customer's operating system and/or database. In another embodiment, guide customizer 134 can add in additional information related to the customer into the downloaded guide. For example, impact analysis of upgrading, updating, or installing the software application can be added to the downloaded guide. The impact analysis can describe what effect the upgrade, update, or install has on the customer landscape. Guide customizer 134 can generate the impact analysis based on the data received from customer profile database 110 and the customer request.

Once the landscape guides have been customized, landscape guide generator 130 can return the customized guides to service marketplace 120 or landscape planner tool 125 at step 7 (reference numeral 257). Service marketplace 120 (or landscape planner tool 125) can in turn return the customized guides to customer management system 140 at step 8 (reference numeral 258). Customer management system 140 receives the customized guides and in turn follows the instructions within the guides to install upgrade, update, or install the software within customer landscape 150.

In some embodiments, guides database 136 can store pre-customized landscape guides. Each pre-customized landscape guide can be customized for a given operating system (or operating system version), database (or database version), source product version, and/or target product version. By storing pre-customized guides, customization of the landscape guides by guide customizer 134 can be reduced, thus saving processing time. Guides database 136 can store multiple landscape guides for a given target product version of a software application. For example, a first pre-customized landscape guide can be configured for upgrading the software application from a source product version of 3.0 to a target product version of 4.5 while a second pre-customized landscape guide can be configured for updating the software application from a source product version of 4.4 to a target product version of 4.5. As another example, a first pre-customized guide can be configured for upgrading the software application running on a first operating system while a second pre-customized guide is configured for upgrading the software application running on a second operating system. In some examples, the pre-customized guides can be specific for a given operating system, database, source product version, and target product version. As a result, guide customizer 134 does not need to remove instructions that are irrelevant to the customer. Guide customizer 134 can still add in additional information related to the customer into the downloaded guide such as impact analysis.

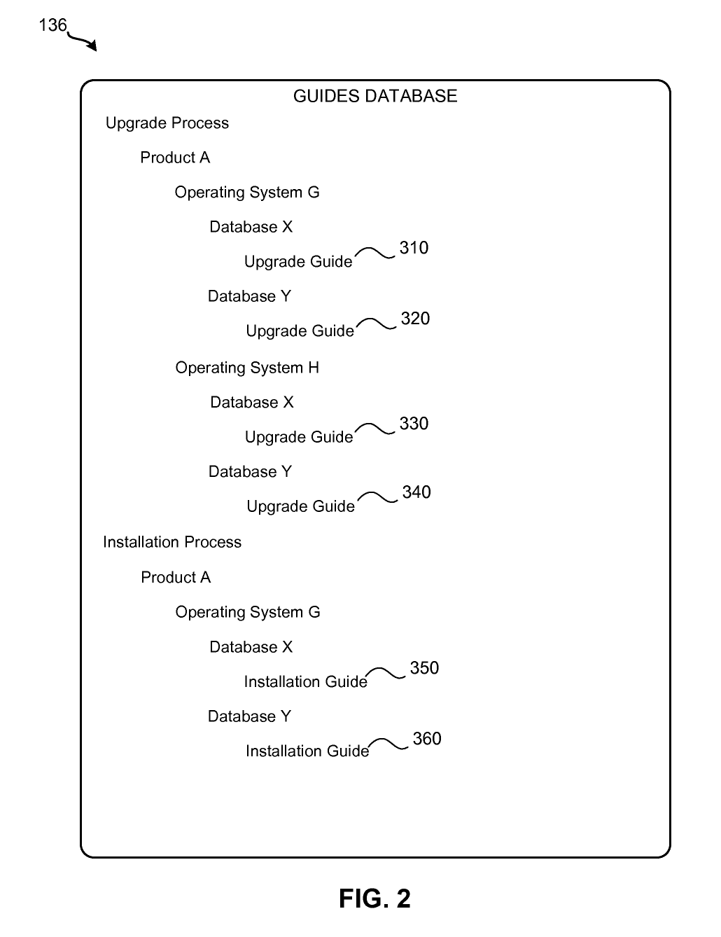

FIG. 2 illustrates a guides database according to one embodiment. Guides database 136 can store landscape guides within a hierarchical data model. Here, pre-customized landscape guides 310, 320, 330, 340, 350, and 360 are stored within guides database 136. The pre-customized guides can be pre-customized for a given product, operating system, and database. Each pre-customized guides can still be further customized for a given source product version and target product version. For example, instructions which are irrelevant when performing an upgrade from the source target version to the target product version can be removed from the pre-customized guide during a customization step. Here, landscape guides are first separated by the SL process. Landscape guides used in an upgrade process are stored under one branch while landscape guides used in an installation process are stored under another branch. Under the upgrade process branch, the landscape guides are stored according to product, then operating system, then database. For example to retrieve upgrade guide 310, the customer would search for upgrade process->product A->operating system G->database X. If fewer parameters are provided, then multiple guides can be returned. For example, upgrade guide 310 and 320 can be returned if the provided parameters are upgrade process->product A->operating system G. In other embodiments, guides database 136 can store guides using other data models or sorted differently. For example, the landscape guides can alternatively be stored based on SL process, followed by operating system, followed by product, followed by database.

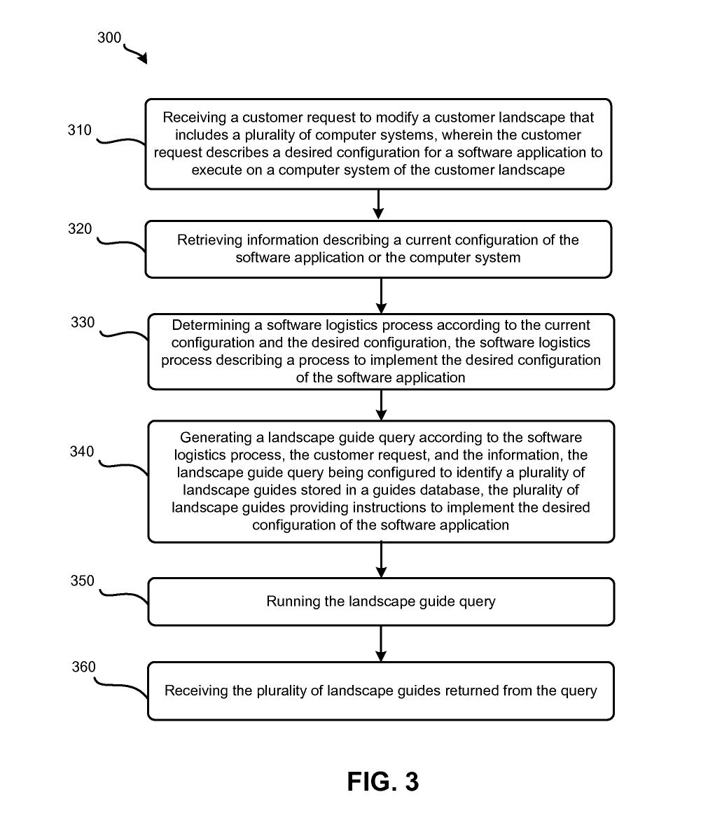

FIG. 3 illustrates an execution process according to one embodiment. Process 300 can be stored in non-transitory computer readable medium and executed by a processor. The processor can be located on the server side of system 100, such as part of service marketplace 120 or landscape guide generator 130. Process 300 begins by receiving a customer request to modify a customer landscape that includes a plurality of computer systems at 310. In one embodiment, the customer request can describe a desired configuration for a software application to execute on a computer system of the customer landscape. For example, the customer request can specify the target product version for a software application. The target product version can describe the version of the software application which the customer wishes to have running on the computer system. The customer request can include an identifier for the customer landscape, the computer system within the customer landscape to run the software application, the target product version, a customer identifier, and other parameters associated with the customer, customer landscape, or software application.

After receiving the customer request, process 300 can continue by retrieving information describing a current configuration of the software application or the computer system. The current configuration of the software application can include the source product version of the software application (e.g., the version of the software application currently installed on the computer system within customer landscape). The current configuration of the computer system can be the operating system currently running on the computer system or the database that the computer system is in communication with. In one embodiment, the information can be retrieved from customer profile database 110.

After retrieving the information, process 300 can continue by determining a software logistics process according to the current configuration and the desired configuration at 330. The software logistics process can describe a process to implement the desired configuration of the software application. For example, the software logistics process can describe that an installation, upgrade, or update is appropriate in this situation. In one embodiment, process 300 can compare the desired configuration with the current configuration to determine the appropriate process to perform. For example, a version identifier for the current configuration of the software application (e.g., source product version) can be compared against a version identifier for the desired configuration of the software application (e.g., target product version). Based on the comparison of the version identifiers, process 300 can determine whether the software logistics process is an installation, upgrade, or update. In one example, the software logistics process can be an installation when the source product version is NIL, implying that no versions of the software application have been installed on the computer system. In another example, the software logistics process can be an update when the source product version and the target product version are versions within the same software release. For instance, the software logistics process can be an update when the source product version is 3.4 and the target product version is 3.5. In yet another example, the software logistics process can be an upgrade when the source product version and the target product version are versions in different software releases. For instance, the software logistics process can be an upgrade when the source product version is 3.4 and the target product version is 4.1, where 3.4 belongs to the 3 product release and 4.1 belongs to the 4 product release.

Once the software logistics process has been determined, process 300 can continue by generating a landscape guide query according to the software logistics process, the customer request, and the information at 340. The landscape guide query can be configured to identify a plurality of landscape guides stored within a guides database. The plurality of landscape guides can provide instructions to implement the desired configuration of the software application. By following the landscape guides, a customer can implement the desired configuration of the software application. In some examples, the landscape guides can include an implementation guide for the target product version of the software, a guide to implement a version of the operating system, a guide to operate software provisioning manager (a tool to provision software on a system), and a guide for operating the software update manager (the tool to update software on a system). In one embodiment, the landscape guide query can include a target product version, source product version, software application identifier, operating system, database, or other parameters that are associated with the desired configuration of the software application.

Process 300 can continue by running the landscape guide query at 350. Running the landscape guide query can include querying a landscape guides database for landscape guides which match the query criteria. In one embodiment, the landscape guides database can process a landscape guide query by identifying landscape guides within the database which match the query criteria. Process 300 can continue by receiving the plurality of landscape guides returned from the query. In some embodiments, process 300 can continue by customizing the received landscape guides for the particular customer. Customization of the landscape guides can include the removal of portions of the landscape guide that are irrelevant to the customer. For example, instructions related to databases or operating systems other than those used by the computer system which the software application is to be installed on can be removed from the landscape guide to minimize the size of the landscape guide and reduce confusion to the customer. As another example, instructions related to the desired configuration from a reference point other than the current configuration can be removed from the landscape guide. For instance, instructions for updating from version 3.3 to 3.5 can be removed from the guide if we are trying to update from version 3.4 to 3.5. In one embodiment, process 300 can identify the source product version, target product version, operating system of the computer system which the desired configuration of the software application is to be running on, and the database (or type of database) which the computer system is in communication with. Based on those parameters, process 300 can reduce the instructions within the landscape guides by removing irrelevant instructions. Furthermore, process 300 can also generate an impact analysis or other reference material and insert it into the landscape guides, thus creating landscape guides which are personalized for the customer.

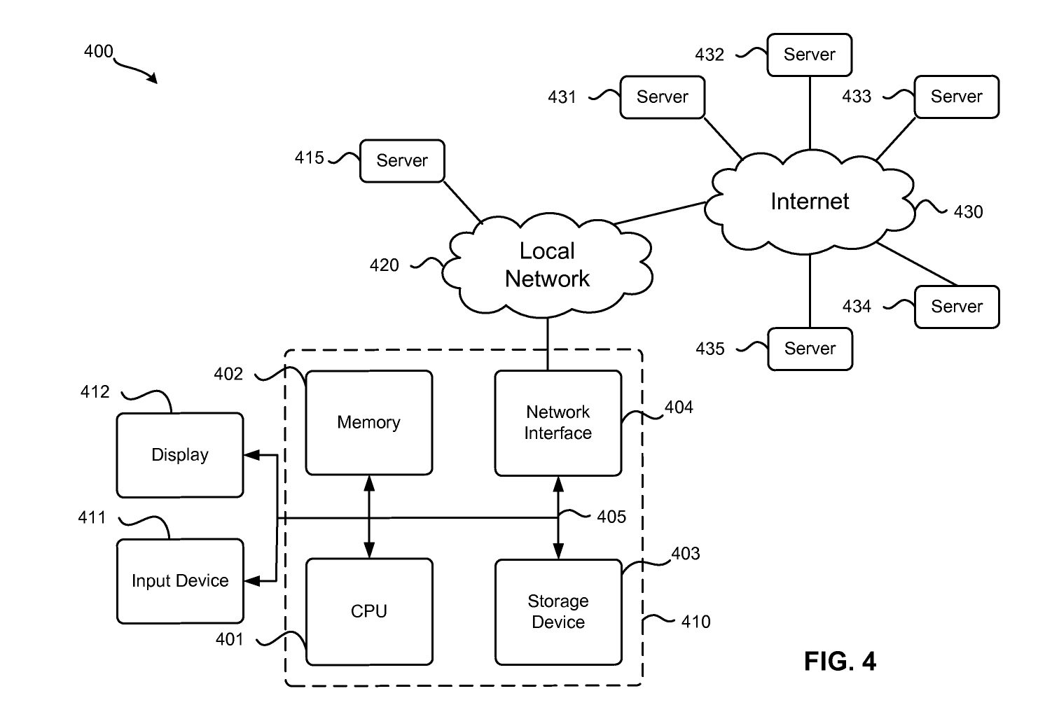

An exemplary computer system 400 is illustrated in FIG. 4. Computer system 410 includes a bus 405 or other communication mechanism for communicating information, and a processor 401 coupled with bus 405 for processing information. Computer system 410 also includes memory 402 coupled to bus 405 for storing information and instructions to be executed by processor 401, including information and instructions for performing the techniques described above, for example. This memory may also be used for storing variables or other intermediate information during execution of instructions to be executed by processor 401. Possible implementations of this memory may be, but are not limited to, random access memory (RAM), read only memory (ROM), or both. A storage device 403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 403 may include source code, binary code, or software files for performing the techniques above, for example. Storage device and memory are both examples of computer readable mediums.

Computer system 410 may be coupled via bus 405 to a display 412, such as a cathode ray tube (CRT) or liquid crystal display (LCD), for displaying information to a computer user. An input device 411 such as a keyboard and/or mouse is coupled to bus 405 for communicating information and command selections from the user to processor 401. The combination of these components allows the user to communicate with the system. In some systems, bus 405 may be divided into multiple specialized buses.

Computer system 410 also includes a network interface 404 coupled with bus 405. Network interface 404 may provide two-way data communication between computer system 410 and the local network 420. The network interface 404 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 404 sends and receives electrical, electromagnetic, or optical signals that carry digital data streams representing various types of information.

Computer system 410 can send and receive information, including messages or other interface actions, through the network interface 404 across a local network 420, an Intranet, or the Internet 430. For a local network, computer system 410 may communicate with a plurality of other computer machines, such as server 415. Accordingly, computer system 410 and server computer systems represented by server 415 may form a cloud computing network, which may be programmed with processes described herein. In the Internet example, software components or services may reside on multiple different computer systems 410 or servers 431-435 across the network. The processes described above may be implemented on one or more servers, for example. A server 431 may transmit actions or messages from one component, through Internet 430, local network 420, and network interface 404 to a component on computer system 410. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

1. A computer-implemented method, comprising:
receiving, by a processor, a customer request to modify a customer landscape that includes a plurality of computer systems, wherein the customer request describes a desired configuration for a software application to execute on a computer system of the customer landscape;
retrieving, by the processor, information describing a current configuration of the software application or the computer system;
determining, by the processor, a software logistics process according to the current configuration and the desired configuration, the software logistics process describing a process to implement the desired configuration of the software application;
generating, by the processor, a landscape guide query according to the software logistics process, the customer request, and the information, the landscape guide query being configured to identify a plurality of downloaded universal landscape guides stored in a guides database, the plurality of downloaded universal landscape guides providing instructions to implement the desired configuration of the software application;
running, by the processor, the landscape guide query; and
receiving, by the processor, the plurality of downloaded universal landscape guides returned from the query.

2. The computer-implemented method of claim 1, further comprising:
customizing, by the processor, a personalized landscape guide from the plurality of downloaded universal landscape guides according to the information describing the current configuration of the software application.

3. The computer-implemented method of claim 2, wherein customizing the personalized landscape guide comprises:
removing, by the processor, one or more instructions from the downloaded universal landscape guide that are irrelevant to the current configuration of the software application.

4. The computer-implemented method of claim 1, wherein the information includes at least one of a source product version configured to identify the version of the software application that is installed on the computer system, an operating system identifier configured to identify the operating system executing on the computer system, and a database identifier configured to identify the database utilized by the computer system.

5. The computer-implemented method of claim 1, wherein retrieving information describing the current configuration of the software application or the computer system comprises:
determining, by the processor, a system identifier for the computer system from the customer request; and
retrieving, by the processor, the information from a customer profile database according to the system identifier.

6. The computer-implemented method of claim 1, wherein determining the software logistics process comprises:
comparing, by the processor, a first version identifier for the current configuration against a second version identifier for the desired configuration; and
determining, by the processor, the software logistics process based on the comparison.

7. The computer-implemented method of claim 6, wherein the software logistics process is determined to be an installation when the first version identifier is set to NIL.

8. A non-transitory computer readable storage medium storing one or more programs, the one or more programs comprising instructions for:
receiving a customer request to modify a customer landscape that includes a plurality of computer systems, wherein the customer request describes a desired configuration for a software application to execute on a computer system of the customer landscape;
retrieving information describing a current configuration of the software application or the computer system;
determining a software logistics process according to the current configuration and the desired configuration, the software logistics process describing a process to implement the desired configuration of the software application;
generating a landscape guide query according to the software logistics process, the customer request, and the information, the landscape guide query being configured to identify a plurality of downloaded universal landscape guides stored in a guides database, the plurality of downloaded universal landscape guides providing instructions to implement the desired configuration of the software application;
running the landscape guide query; and
receiving the plurality of downloaded universal landscape guides returned from the query.

9. The non-transitory computer readable storage medium of claim 8, further comprising:
customizing a personalized landscape guide from the plurality of downloaded universal landscape guides according to the information describing the current configuration of the software application.

10. The non-transitory computer readable storage medium of claim 9, wherein customizing the personalized landscape guide comprises:
removing one or more instructions from the downloaded universal landscape guide that are irrelevant to the current configuration of the software application.

11. The non-transitory computer readable storage medium of claim 8, wherein the information includes at least one of a source product version configured to identify the version of the software application that is installed on the computer system, an operating system identifier configured to identify the operating system executing on the computer system, and a database identifier configured to identify the database utilized by the computer system.

12. The non-transitory computer readable storage medium of claim 8, wherein retrieving information describing the configuration of the software application or the computer system comprises:
determining a system identifier for the computer system from the customer request; and
retrieving the information from a customer profile database according to the system identifier.

13. The non-transitory computer readable storage medium of claim 8, wherein determining the software logistics process comprises:
comparing a first version identifier for the current configuration against a second version identifier for the desired configuration; and
determining the software logistics process based on the comparison.

14. The non-transitory computer readable storage medium of claim 13, wherein the software logistics process is determined to be an installation when the first version identifier is set to NIL.

15. A computer system, comprising:
a processor; and
a memory storing a data storage configured to cause the processor to,
receive a customer request to modify a customer landscape, the customer landscape including a plurality of computer systems and the customer request being configured to alter the configuration of software applications running on a computer system of the customer landscape;
receive a customer request to modify a customer landscape that includes a plurality of computer systems, wherein the customer request describes a desired configuration for a software application to execute on a computer system of the customer landscape;
retrieve information describing a current configuration of the software application or the computer system;
determine a software logistics process according to the current configuration and the desired configuration, the software logistics process describing a process to implement the desired configuration of the software application;
generate a landscape guide query according to the software logistics process, the customer request, and the information, the landscape guide query being configured to identify a plurality of downloaded universal landscape guides stored in a guides database, the plurality of downloaded universal landscape guides providing instructions to implement the desired configuration of the software application;
run the landscape guide query; and
receive the plurality of landscape guides returned from the query.

16. The computer system of claim 15, further comprising:
customizing a personalized landscape guide from the plurality of downloaded universal landscape guides according to the information describing the current configuration of the software application.

17. The computer system of claim 16, wherein customizing the landscape guide comprises:
removing one or more instructions from the downloaded universal landscape guide that are irrelevant to the current configuration of the software application.

18. The computer system of claim 15, wherein the information includes at least one of a source product version configured to identify the version of the software application that is installed on the computer system, an operating system identifier configured to identify the operating system executing on the computer system, and a database identifier configured to identify the database utilized by the computer system.

19. The computer system of claim 18, wherein determining the software logistics process comprises:
comparing a first version identifier for the current configuration against a second version identifier for the desired configuration; and
determining the software logistics process based on the comparison.

20. The computer system of claim 19, wherein the software logistics process is determined to be an installation when the first version identifier is set to NIL.
